(19) United States
(12) Patent Application Publication
(10) Pub. No.: US 2005/0070157 A1
(43) Pub. Date: Mar. 31, 2005

(54) Dual digital data connector

(76) Inventors: Lay Ling Neo, Singapore (SG); Gek Hoon Quat, Singapore (SG); Hiap Chew Chua, Singapore (SG)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/676,504

(22) Filed: Sep. 30, 2003

(51) Int. Cl. H01R 13/60

(52) U.S. Cl. 439/542

(57) ABSTRACT

A dual data connector to enable a digital apparatus to be connected to at least one host apparatus, the dual connector comprising a first connecting of a first interface for connecting with a corresponding further connecting part of the first interface of an apparatus; and a part connecting part of a second interface for connecting with a corresponding other connecting part of the second interface of the apparatus, the first connecting part being electrically in parallel with the second connecting part, such that if the apparatus has only one of the first interface and the second interface, the relevant one of the first connecting part and the connecting part can be used to enable data transfer to take place. A portable digital data storage device with dual data connectors is also disclosed.

### FIELD OF THE INVENTION

The present invention relates to a dual digital data connector, and refers particularly, though not exclusively, to a dual digital data connector to enable a digital apparatus to connect to a different hosts.

### BACKGROUND OF THE INVENTION

There are presently many digital data connectors, and the interfaces required to be used with them. These include, but are not limited to: USB, IEEE 1394, Multi Media Card, Smartmedia, Memory Stick, secure digital, compact flash, and so forth. All require the use of a corresponding and mating port, and a dedicated interface. The connectors and interfaces are used with various forms of digital apparatus including, but not limited to: personal computers, notebook computers, laptop computers, tablet computers, personal digital assistants, mobile telephones, digital cameras, MP3 players, digital projectors, keyboard, mouse, sound reproducing apparatus, peripheral devices, portable data storage devices, printers, WiFi terminals, or any combination of them, and so forth. Most interfaces have a relatively complicated host interface, and interfaces/connectors are not generally interchangable. Therefore, if a digital apparatus has a particular connector/interface, it can only be used with a host apparatus if the host has the corresponding port/interface. This limits the flexibility in use of many items of digital apparatus.

### SUMMARY OF THE INVENTION

According to a preferred aspect of the invention, there is provided a dual data connector to enable a digital apparatus to be connected to at least one host apparatus, the dual connector comprising a first connecting part of a first interface of a digital apparatus for operative connection with a corresponding second connecting part of the first interface of a host apparatus; and a third connecting part of a second interface of the digital apparatus for operative connection with a corresponding fourth connecting part of the second interface of the host apparatus; the first connecting part being electrically in parallel with the third connecting part, such that if the host apparatus has only one of the first interface and the second interface, the relevant one of the first connecting part and the third connecting part can be used to enable data transfer to take place between the digital apparatus and the host apparatus.

If the host apparatus has the first interface and the second interface, it is preferable that at any one time data is able to be transferred between the appliance and the apparatus using only one of: the first connecting part and the second connecting part and the third connecting and the fourth connecting part.

The first connecting part may be a female connector, the third connecting part may be a male connector. Alternatively, the first connecting part may be a male connector, and the third connecting part may be a female connector.

There may be further included a data storage memory operatively connected to the first connecting part and the third connecting part; a first digital interface between the data storage memory and the first connecting part; and a second digital interface between the digital data memory and the third connecting part. When the first interface and second interface are able to be used, a power connection of the third connecting part and fourth connecting part may be able to be used to provide electrical power to the digital apparatus from the host apparatus.

The digital apparatus may be a portable data storage device. There may be further included a data storage memory operatively connected to the first connecting part and the third connecting part, a first digital interface between the data storage memory and the first connecting part, and a second digital interface between the digital data memory and the third connecting part; the first connecting part being a female connector, and the third connecting part being a male connector. The present invention also extends to a digital apparatus including such a dual data connector.

In a further form, there is provided an adapter for a digital apparatus, the adapter having a first port of a first interface for operative connection with a first connector of a first digital apparatus; the adapter having a second connector of a second interface for connecting with a corresponding second port of a second digital apparatus; the first port being operatively connected to the second connector within the adapter.

The first digital apparatus may be a portable digital data memory device, and the second digital apparatus may be a host apparatus.

Another form of the invention provides a portable digital data storage device having a first connecting part of a first interface of a digital apparatus for operative connection with a corresponding second connecting part of the first interface of a host apparatus; and a third connecting part of a second interface of the digital apparatus for operative connection with a corresponding fourth connecting part of the second interface of the host apparatus; the first connecting part being electrically in parallel with the third connecting part; the first connecting part and the third connecting part being spaced from each other such one of the first and third connecting parts does not interfere with the use of the other of the first and third connecting parts. The first connecting part may be a female connector, and the third connecting part may be a male connector. Alternatively, the first connecting part may be a male connector, and the third connecting part may be a female connector.

In all forms, the first interface and the second interface may each be selected from the group consisting of: Smartmedia, multi media card, secure digital, compact flash, USB, IEEE 1394, NAND flash interface, AND flash interface, serial protocol interface, integrated device electronics interface, serial peripherals interface, intra-integrated circuit interface, xD-Picture interface, and Memory Stick.

The digital data storage device may include a data storage memory operatively connected to the first connecting part and the third connecting part, and a first digital interface between the data storage memory and the first connecting part.

### BRIEF DESCRIPTION OF THE DRAWINGS

In order that the invention may be better understood and readily put into practical effect, there shall now be described by way of non-limitative example only preferred embodiments of the present invention, the description being with reference to the accompanying illustrative drawings in which:

FIG. 1 is a perspective view of a first embodiment prior to connection to apparatus;

FIG. 2 is an illustration of one form of system architecture;

FIG. 3 is a perspective view of the device of FIG. 1;

FIG. 4 is a perspective view of the device of FIG. 3 interfacing with a first apparatus;

FIG. 5 is a perspective view of the device of FIG. 3 interfacing with a second apparatus;

FIG. 6 is a perspective view of a second embodiment prior to assembly;

FIG. 7 is a perspective view of the device of FIG. 6 interfacing with the first apparatus; and

FIG. 8 is a perspective view of the device of FIG. 6 interfacing with the second apparatus.

### DETAILED DESCRIPTION OF THE PREFERRED EMBODIMENT

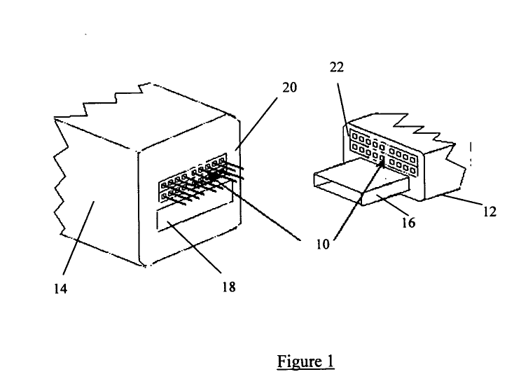

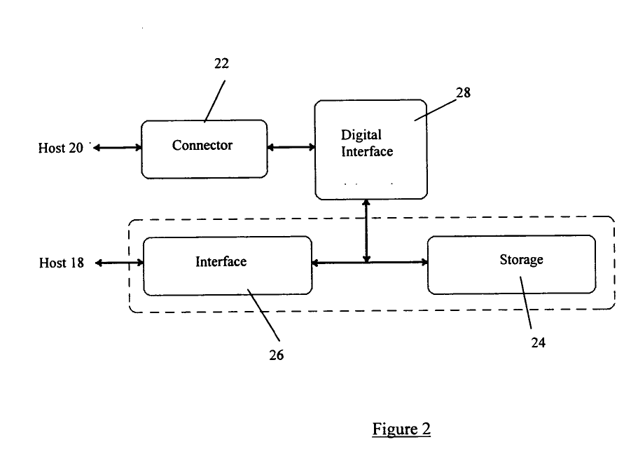

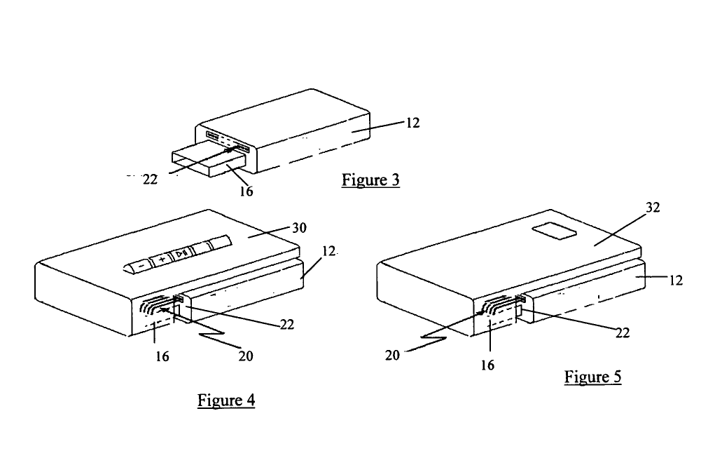

To first refer to FIGS. 1 and 3, there is shown an interface 10 of a digital appliance 12 for engagement with an apparatus 14. The apparatus 14 and/or the digital appliance may be, for example, a personal computer, laptop computer, notebook computer, tablet computer, personal digital assistant, MP3 player, digital camera, mobile telephone, digital projector, keyboard, mouse, sound reproducing apparatus (including external sound cards and/or speakers), external drivers (VCD, CD, and so forth), portable data storage devices, printers, WiFi terminals, or other digital device.

The device 12 may also have a known connector 16 such as a USB connector (as illustrated), an IEEE 1394 connector, or other known digital data connector. The known connector 16 interfaces with a corresponding port 18 in equipment 14. A USB connector has four terminals—ground, power, and two for data. The connector 16/18 is electrically in parallel with interface 10. When device 12 is connected to apparatus 14, and both ports 18 and 20 are operatively connected to connectors 16 and 22 respectively, and apparatus 14 has hosts for both, the host will determine which interface is to be used. If the host apparatus 14 uses interface 10 for data transfer, the ground and power of the USB connector 16/18 may be used, if desired or required, to pass power from apparatus 14 to device 12 even if the data transfer is not through the two data lines of the USB connector 16/18.

The interface 10 may have a male connector 20 and a female connector 22. One will be on the apparatus 14 and the other on the device 12. As shown, the male connector 20 is on the apparatus 14 and the female connector 22 is on the device 12; but this may be reversed. It is preferred that the device have one male connector and one female connector to facilitate non-interference of one connector with the operation of the other.

As shown in FIG. 2, the device 12 may have a data storage memory 24 that is non-volatile. Preferably, it is flash memory. Memory 24 may include its own interface (not shown), and there will be a controller (not shown). There is also an interface 26 for interfacing with the host port 18 via connector 16, and thus the host interface. Connected between storage 24 and interface 26 is digital interface 28 that is operatively connected to connector 22. Connector 22 can connect with host via port 20.

Apart from power from the USB connector 16, when interface 10 is in use passing data to or from device 12, preferably no data would pass through USB port 18 and connector 20; and when USB port 18 and connector 20 are in use passing data to or form device 12, preferably no data would pass through interface 10. Data flow is preferably through one or the other at the one time, not both. However, data flow may be one way by one, and the other way by the other. For example, download using interface 10 and upload using the USB connection; or vice versa.

Alternatively, interface 10 may be used for one form of data (e.g. data for memory 24) and port 18/connector 20 may be used for a different form of data (e.g. control data). This may be at the same time, or sequentially.

If interface 10 is similar to the memory 24 (e.g. a flash interface with flash memory), digital interface 28 may not be required as interface 10 will include all relevant protocols for data transfer.

FIGS. 4 and 5 show device 12 in use with an MP3 player 30, and a digital camera 32, respectively. By using interface 10, player 30 and camera 32 do not inherently require a USB host. Connector 16 may engage in a port solely to provide power to device 12 (if required), with there being no data terminals to operatively connect with the data lines in connector 16. As can be seen, the interface 10 is arranged adjacent to, but separated from, connector 16. The spacing between them should be sufficient for use of one to not interfere with the other. In this way interface 10 can be used alone if the equipment 14, 30, 32 does not have a suitable port for connector 16; and connector 16 can be used alone if the equipment 14, 30, 32 does not have interface 10. Although the interface 10 and connector/port 16, 18 are shown adjacent, they could be physically remote. For example, interface 10 could be at one end of device 12, and connector 16 at the opposite end. The electrical relationship would be the same, except that it would be a case of using interface 10 or connector 16. Preferably, interface 10 and connector 16 are also physically in parallel, as well as electrically.

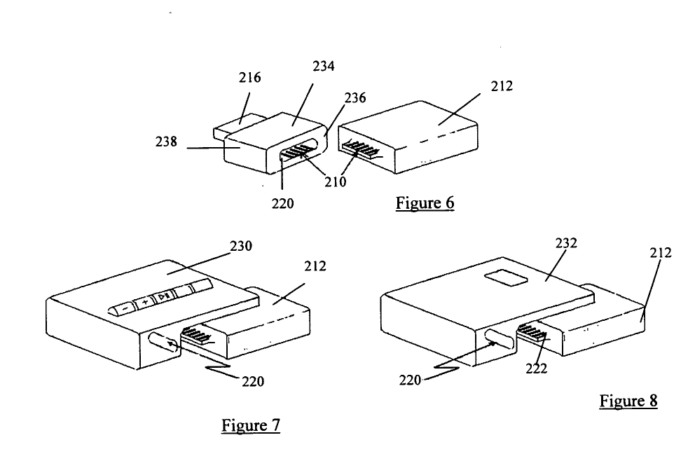

In FIGS. 6 to 8 there is shown a second embodiment. With the second embodiment like components have like reference numerals with an extra, prefix number “2”.

The device 212 has a single interface 210. The interface any form of interface, as is described above. The interface 210 has a male connector 222 for operative connection with a port 220. Again, it may be used with any suitable apparatus such as, for example, MP3 player 230 (FIG. 7) and digital camera 232 (FIG. 8).

If the apparatus 14, 230, 232 does not have a port 220 able to operatively connect with connector 222, an adapter 234 may be provided. Adapter 234, on one end 236, has a port 220 able to operatively connect with connector 222 and, at other end 238, has a connector 216 such as, for example, a USB connector (as shown). Port 220 and connector 216 are operatively connected within adapter 234. In this way device 212 can be used with any port for which an adapter 234 is available. If interface 210 has a female connector on device 212 and male connector on apparatus 14, 230, 232, the adapter 234 can be turned 180° and used. The adapter is shown as a male/female adapter. It may also be male/male or female/female.

Whilst there has been described in the foregoing description preferred embodiments of the present invention, it will be understood by those skilled in the technology that many variations or modifications in details of design or construction or operation may be made without departing from the present invention.

1. A dual data connector to enable a digital apparatus to be connected to at least one host apparatus, the dual connector comprising a first connecting part of a first interface of the digital apparatus for operative connection with a corresponding second connecting part of the first interface of the host apparatus; and a third connecting part of a second interface of the digital apparatus for operative connection with a corresponding fourth connecting part of the second interface of the host apparatus; the first connecting part being electrically in parallel with the third connecting part, such that if the host apparatus has only one of the first interface and the second interface, the relevant one of the first connecting part and the third connecting part can be used to enables data transfer to take place between the digital apparatus and the host apparatus.

2. A dual data connector as claimed in claim 1, wherein if the host apparatus has the first interface and the second interface, at any one time data is able to be transferred between the appliance and the apparatus using only one of: the first connecting part and the second connecting part and the third connecting and the fourth connecting part.

3. A dual data connector as claimed in claim 1, wherein the first connecting part is a female connector, the third connecting part is a male connector.

4. A dual data connector as claimed in claim 1, wherein the first connecting part is a male connector, and the third connecting part is a female connector.

5. A dual data connector as claimed in claim 1, wherein the first interface and the second interface are each selected from the group consisting of: Smartmedia, multi media card, secure digital, compact flash, USB, IEEE 1394, NAND flash interface, AND flash interface, serial protocol interface, integrated device electronics interface, serial peripherals interface, intra-integrated circuit interface, xD-Picture interface, and Memory Stick.

6. A dual data connector as claimed in claim 1, further including a data storage memory operatively connected to the first connecting part and the third connecting part.

7. A dual data connector as claimed in claim 6, wherein there is provided a first digital interface between the data storage memory and the first connecting part.

8. A dual data connector as claimed in claim 6, further including a second digital interface between the digital data memory and the third connecting part.

9. A dual data connector as claimed in claim 1, wherein when the first interface and second interface are able to be used, a power connection of the third connecting part and fourth connecting part is able to be used to provide electrical power to the digital apparatus from the host apparatus.

10. A dual data connector as claimed in claim 1, wherein the digital apparatus is a portable data storage device.

11. A dual data connector as claimed in claim 10, further including a data storage memory operatively connected to the first connecting part and the third connecting part, a first digital interface between the data storage memory and the first connecting part, and a second digital interface between the digital data memory and the third connecting part; the first connecting part being a female connector, and the third connecting part being a male connector.

12. Digital apparatus including a dual data connector as claimed in claim 1.

13. Digital apparatus including a dual data connector as claimed in claim 11.

14. Digital apparatus as claimed in claim 13, wherein the digital apparatus is a portable digital data storage device.

15. An adapter for a first digital apparatus, the adapter having a first port of a first interface for operative connection with a first connector of the first digital apparatus; the adapter having a second connector of a second interface for connecting with a corresponding second port of a second digital apparatus; the first port being operatively connected to the second connector within the adapter.

16. An adapter as claimed in claim 15, wherein the first port and the second connector are each selected from the group consisting of: Smart media, Multimedia Card, secure digital, compact flash, USB, IEEE 1394, NAND flash interface, AND flash interface, serial protocol interface, integrated device electronics interface, serial peripherals interface, intra-integrated circuit interface, xD-Picture interface, and Memory Stick; the first port and the second connector being different.

17. An adapter as claimed in claim 16, wherein the first digital apparatus is a portable digital data memory device, and the second digital apparatus is a host apparatus.

18. A portable digital data storage device having a first connecting part of a first interface of a digital apparatus for operative connection with a corresponding second connecting part of the first interface of the portable digital data storage device; and a third connecting part of a second interface of the digital apparatus for operative connection with a corresponding fourth connecting part of the second interface of the portable digital data storage device; the first connecting part being electrically in parallel with the third connecting part; the first connecting part and the third connecting part being spaced from each other such one of the first and third connecting parts does not interfere with the use of the other of the first and third connecting parts.

19. A portable digital data storage device as claimed in claim 18, wherein the first connecting part is a female connector, the third connecting part is a male connector.

20. A portable digital data storage device as claimed in claim 18, wherein the first connecting part is a male connector, and the third connecting part is a female connector.

21. A portable digital data storage device as claimed in claim 18, wherein the first interface and the second interface are each selected from the group consisting of: Smartmedia, multi media card, secure digital, compact flash, USB, IEEE 1394, NAND flash interface, AND flash interface, serial protocol interface, integrated device electronics interface, serial peripherals interface, intra-integrated circuit interface, xD-Picture interface, and Memory Stick.

22. A portable digital data storage device claimed in claim 18, further including a data storage memory operatively connected to the first connecting part and the third connecting part.

23. A portable digital data storage device as claimed in claim 22, wherein there is provided a first digital interface between the data storage memory and the first connecting part.

24. A portable digital data storage device as claimed in claim 18, further including a data storage memory operatively connected to the first connecting part and the third connecting part, a first digital interface between the data storage memory and the first connecting part, and a second digital interface between the digital data memory and the third connecting part; the first connecting part being a female connector, and the third connecting part being a male connector.
